(19) United States
(12) Patent Application Publication
(10) Pub. No.: US 2008/0317293 A1
(43) Pub. Date: Dec. 25, 2008

(54) Finger vein authentication apparatus and information processing apparatus

(76) Inventors: Soichi Sakurai, Yokohama (JP); Hitoshi Takizawa, Yokohama (JP); Naoto Miura, Kokubunji (JP); Harumi Kiyomizu, Kokubunji (JP); Hiroaki Ono, Fujisawa (JP); Shigeyuki Sudo, Yokohama (JP); Shoichi Sato, Ebina (JP)

Correspondence Address: MCDERMOTT WILL & EMERY LLP, 600 13TH STREET, N.W., WASHINGTON, DC, 20005-3096, US

(21) Appl. No.: 12/073,168

(22) Filed: Feb. 29, 2008

(30) Foreign Application Priority Data
Jun. 22, 2007 (JP) 2007-165614
Sep. 21, 2007 (JP) 2007-246024
Oct. 2, 2007 (JP) 2007-259169

(51) Int. Cl. G06K 9/00

(52) U.S. Cl. 382/115

(57) ABSTRACT

Provided is a finger vein authentication apparatus including a light source for emitting light toward a finger, an image sensor for taking an image of the transmitted light from the finger, a lens apparatus for imaging the transmitted light to the image sensor, and an image processor for processing the taken image. The lens apparatus includes a lens unit, and the image processor extracts a vein pattern of the finger upon correcting the strain of the taken image.

### CROSS-REFERENCES

This application relates to and claims priority from Japanese Patent Application No. 2007-165614, filed on Jun. 22, 2007, No. 2007-246024, filed on Sep. 21, 2007, and No. 2007-259169, filed on Oct. 2, 2007, the entire disclosure of which is incorporated herein by reference.

### BACKGROUND

The present invention generally relates to a finger vein authentication apparatus and an information processing apparatus using such a finger vein authentication apparatus, and in particular relates to technology for miniaturizing the finger vein authentication apparatus.

Among the various types of security technology available today, a finger vein pattern is known to realize high-precision authentication. Finger vein authentication realizes superior authentication precision as a result of using the internal finger vein pattern, and thereby realizes high-level security since impersonation and falsification are far more difficult in comparison to fingerprint authentication.

As a conventional example of this type of finger vein authentication, for instance, there is the biometric authentication apparatus described in Japanese Patent Laid-Open Publication No. 2006-155575. This biometric authentication apparatus comprises a light source for emitting light that passes through a finger, an imaging unit for imaging the light that passed through the finger, a finger detection means for detecting that the finger exists at a prescribed position, a finger area extraction means for extracting the area occupied by the finger from the image taken with the imaging unit, and a gain changing means for changing the gain of the image sensor in the imaging unit based on the image quality of a specific portion in the extracted area.

### SUMMARY

Finger vein authentication is advantageous in that the authentication apparatus can be miniaturized in comparison to palm vein authentication. Nevertheless, in recent years, pursuant to the popularization of e-commerce and online banking using compact information apparatuses such as a mobile phone, there are demands for further miniaturization of the finger vein authentication apparatus for application in such compact information apparatuses.

Although the biometric authentication apparatus described in Japanese Patent Laid-Open Publication No. 2006-155575 is an imaging method that is able to constantly obtain the quality of an optimal vein pattern without being affected by differences in the external environment when imaging the finger vein pattern with transmitted light, there is no description concerning the miniaturization of the authentication apparatus.

Thus, an object of the present invention is to provide a finger vein authentication apparatus that can be applied to a compact apparatus such as a mobile phone, and an information processing apparatus comprising such a finger vein authentication apparatus.

In order to achieve the foregoing object, the finger vein authentication apparatus according to the present invention comprises a case for mounting a finger, a light source for emitting light toward the finger mounted on the case, an image sensor for taking an image of the interior portion of the finger with the light, a lens apparatus having a lens unit for imaging the light from the finger to the image sensor, and an image processor having a pattern extractor for extracting a vein pattern of the finger from the image taken with the image sensor, and an image corrector for correcting the strain of the image.

In addition, the information processing apparatus according to the present invention comprises the foregoing finger vein authentication apparatus, and a personal authentication apparatus for performing personal authentication based on an image of the strain-corrected vein pattern output from the finger vein authentication apparatus, and performs e-commerce processing based on the authentication result of the personal authentication apparatus.

According to the present invention, it is possible to provide a finger vein authentication apparatus that can be applied to a compact apparatus such as a mobile phone, and an information processing apparatus comprising such a finger vein authentication apparatus.

### DESCRIPTION OF DRAWINGS

FIG. 1 is a perspective view showing an example of a finger vein authentication apparatus;

FIG. 2 is a perspective view showing the status where a finger is mounted on the finger vein authentication apparatus;

FIG. 3 shows an example of the front view of a fragment of the finger vein authentication apparatus;

FIG. 4 is a schematic diagram showing an example of the internal configuration of the finger vein authentication apparatus and the positional relationship with the finger;

FIG. 5 is a perspective view showing an example of a mobile phone equipped with the finger vein authentication apparatus;

FIG. 6 shows an example of an image (with strain) obtained with an image sensor;

FIG. 7 shows an example of a corrected image after performing strain correction to the image obtained with the image sensor;

FIG. 8 is a characteristics chart showing an example of the relationship between the object height and strain (%);

FIG. 9 is a characteristics chart showing an example of the relationship between the object height and the sensitivity ratio of the lens unit;

FIG. 10 is a block diagram showing a configuration example concerning the image processing function of the finger vein authentication apparatus;

FIG. 11A is a plan view, FIG. 11B is a right side view and FIG. 11C is a front view showing an example of the mobile phone equipped with the finger vein authentication apparatus;

FIG. 12 is a perspective view showing an example of a status where a user is holding the mobile phone with one hand;

FIG. 13 is a perspective view showing an example of a status where a user is holding the mobile phone with one hand;

FIG. 14 is a diagram showing an example of the A-A cross section of the finger vein authentication apparatus illustrated in FIG. 1;

FIG. 15 is a diagram showing an example of the B-B cross section of the finger vein authentication apparatus illustrated in FIG. 1;

FIG. 16 is a diagram explaining an optics model pertaining to finger vein authentication;

FIG. 17 is a cross section showing an example of the internal configuration of the finger vein authentication apparatus comprising a light guide;

FIG. 18 is a perspective view showing an example of the finger vein authentication apparatus;

FIG. 19A and FIG. 19B respectively shows a cross section of a status viewing the finger vein authentication apparatus illustrated in FIG. 2 from the fingertip side;

FIG. 20A-FIG. 20F respectively shows a plan view of a case explaining a plurality of modes upon arranging a light source in the [finger] vein authentication apparatus;

FIG. 21A is a plan view of a case comprising another embodiment of a shading wall, and FIG. 21B is a cross section viewing this case from the fingertip side;

FIG. 22A is a plan view of a case comprising yet another embodiment of a shading wall, and FIG. 22B is a cross section viewing this case from the fingertip side;

FIG. 23A is a plan view of a case comprising still another embodiment of a shading wall, and FIG. 23B is a cross section viewing this case from the fingertip side;

FIG. 24A is a cross section of a status viewing a case of the finger vein authentication apparatus equipped with a neutral density filter from the fingertip side, FIG. 24B is a plan view thereof, and FIG. 24C is a plan view of the neutral density filter;

FIG. 25 is a characteristics chart showing the relationship between the object height of a lens unit that changes the conjugate distance from 5 mm to 8 mm, and the peripheral sensitivity ratio;

FIG. 26 is a characteristics chart showing the relationship between the object height of a lens unit that changes the conjugate distance from 5 mm to 8 mm, and the optical strain;

FIG. 27 is an image obtained with the image sensor under the same conditions as FIG. 6 using a short focus lens unit in which the focal distance is 0.15 mm or greater and 0.20 mm or less, the optical strain is −2% to +50%, the paraxial magnification is 0.04 or greater and 0.06 or less, and the sensitivity ratio is 40% or greater and the conjugate distance is 8 mm or less at an object-side maximum field angle;

FIG. 28 is a cross section of the width direction of the finger vein authentication apparatus equipped with the light guide having a configuration that is different from FIG. 17;

FIG. 29 is a perspective view of the overall light guide showing an example of the light guide;

FIG. 30A is a perspective view of the overall light guide showing another example of the light guide, and FIG. 30B shows the outline of the shape in the groove of the light guide;

FIG. 31 is a perspective view of the overall light guide showing yet another example of the light guide;

FIG. 32 is a cross section showing the outline of a status where the light guides existing on either side of the finger vein authentication apparatus are formed in an asymmetrical shape; and

FIG. 33 is a side view of a case showing an outline of an appearance where the height in relation to the case of the light guide gradually becomes higher from the fingertip side toward the palm side.

### DETAILED DESCRIPTION

A finger vein authentication apparatus that is suitable for mounting on a compact apparatus such as a mobile phone is explained below. With this finger vein authentication apparatus, light from a light source such as an LED (Light Emitting Diode) provided under the finger (finger pulp side) is irradiated into the finger, an image is taken based on the light (this light is hereinafter referred to as “transmitted light”) emitted outside the finger under the influence of the internal environment of the finger including the shape of the finger vein (vein pattern), such as light passing through the veins or being reflected off the veins among the light that scattered inside the finger, and a vein pattern is extracted from the foregoing image to authenticate the identification of the user.

In order for the imaging unit of the finger vein authentication apparatus to take a clear image of the finger vein pattern, it is desirable that the following optical conditions are satisfied. Foremost, it is desirable that the imaging unit does not take an image of the infrared light reflected off the surface of the finger skin. If this condition is not satisfied, the image of the finger vein pattern will include unwanted information such as the surface wrinkles of the finger skin, and will become unclear.

Secondly, it is desirable that the imaging unit does not take an image of the scattered infrared light that did not reach the depth where the finger veins exist. If this condition is not satisfied, infrared light that does not include information on the finger vein pattern will deteriorate the contrast of the finger vein pattern.

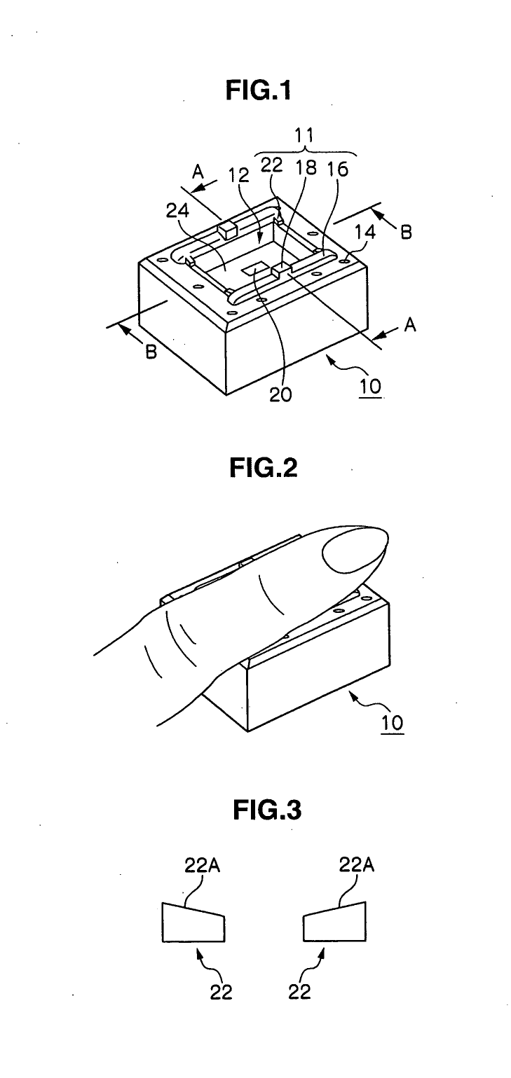

FIG. 1 is a perspective view showing an example of the finger vein authentication apparatus that is configured from a case 10 that is formed in an overall cubical shape. As shown in FIG. 2, the planar side of the case 10 is provided with a finger guide unit 11 for mounting a finger. The finger guide unit 11 is configured from a wall 16, a small protrusion 18 and a fragment 22.

The planar side of the case 10 is also provided with a groove 12 for separating the finger to be authenticated and the optical system described later in order to secure the focal distance. As described later, in this example, since it is possible to reduce the depth of the groove 12 by applying a short focus wide angle lens unit in the optical system, the size of the finger vein authentication apparatus can be miniaturized in the thickness direction.

The width of the groove 12 is narrower than the finger width. The user, as shown in FIG. 2, places one's finger so as to cover the entire groove 12. It is thereby possible to prevent the light emitted from the light irradiation port 14 mounted on the lateral face of the finger and the outside light from being directly irradiated onto the pulp side surface of the finger on the groove 12. Since it is possible to eliminate light that will reflect on the surface of the finger pulp and reach the optical system under the groove 12, a clear vein image can be taken.

The irradiation port 14 is provided to the outside of the finger guide unit 11 in order to emit light generated from the light source such as an LED arranged inside the case 10 toward the lateral face of the user's finger mounted on the finger guide unit 11. Although the irradiation port 14 is shaped in a circle in this example, the configuration is not limited thereto, and the shape may be an oval shape or a polygonal shape such as a square.

The bottom face 24 of the groove 12 is provided with a transmitted light intake port 20 of, for example, a rectangular shape (oblong shape) for taking in the transmitted light from the finger. An IR filter is laid on the transmitted light intake port 20. The IR filter blocks outside light such as sunlight and fluorescent light which are unneeded for the authentication, and further prevents dust and droplets from entering inside the authentication apparatus. The lens apparatus and image sensor arranged below the bottom face 24 take images based on the transmitted light taken in from the transmitted light intake port 20.

The wall 16 protrudes on the finger side with a relatively short height, and is formed in a reed shape along the longitudinal direction of the finger on either side of the finger. Moreover, since the walls 16 formed in a pair are facing each other in parallel, they comprise the function of supporting both lateral faces of the finger upon the finger being mounted on the planar surface of the case 10, and it is thereby possible to prevent the finger from shifting in the horizontal direction upon mounting the finger on the case 10 and taking an image of the finger veins.

In addition, the wall 16 is created with a material that is nontransparent to infrared light. The wall 16 thereby yields the function of guiding the light emitted from the plurality of light exit ports 15 arranged on the outer edge of the planar portion of the case toward the lateral face of the finger, rather than underneath the finger.

When the wall 16 allows the light from the lateral face of the finger to enter the finger, the light quantity that reaches the deep portion of the finger increases in relation to the vein pattern to be imaged, and the optic element of the reflected light from the finger pulp surface that deteriorates the image quality as described above is thereby reduced. Thus, it is possible to take an image of a finger vein pattern with clear transmitted light. In addition, since the wall 16 is able to irradiate light on the lateral face of the finger at a position that is higher than the pulp of the finger, the finger vein authentication apparatus is able to take a sharp vein image.

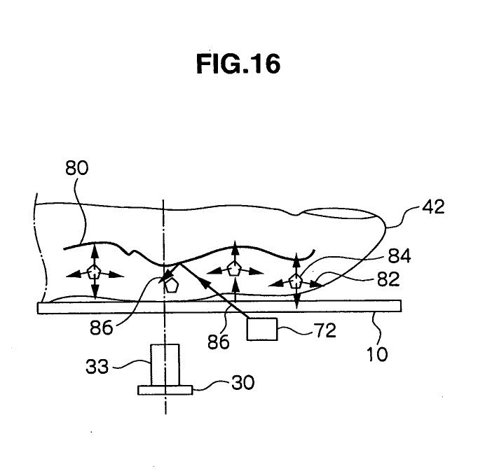

As shown in FIG. 16, if light enters the finger from the bottom face of the finger and not from the lateral face of the finger, the light will scatter in the directions shown with the arrows 82 due to the influence of scattered substances 84 such as the surface skin of the finger or the finger tissue, and the light that does not reach the vein pattern 80 to be imaged will reflect toward the image sensor 30. Thereby, light that does not contain vein information will focus on the image sensor, and there is a problem in that the contrast of the image corresponding to the vein will deteriorate.

Contrarily, if the finger vein authentication apparatus is able to enter light from the lateral face of the finger, it will be possible to avoid the optic element of the reflected light, which deteriorates the contrast as described above, from reaching the lens apparatus 33, and increase the ratio of the transmitted light 86, which includes vein pattern information as a result of reaching the deep portion of finger and passing through the finger veins or reflecting off the veins, reaching the lens apparatus 33.

Further, a small protrusion 18 of a short rectangular shape that protrudes toward the finger side is provided to roughly the center of the longitudinal direction of the wall 16. This small protrusion plays the role of pointing to the first joint of the finger, and the user mounts one's finger on the case so that the first joint of the finger touches the pair of small protrusions 18. The lens unit and image sensor described later are thereby able to take in the vein pattern near the first joint of the finger. Since the finger joint is concave in comparison to the anteroposterior position thereof, the small protrusion 18 easily fits into such concave portion.

With finger vein authentication, the vein pattern near the first joint of the finger is effective for high-precision biometric identification. Thus, preferably, the transmitted light intake port 20 is of a rectangular shape having an area capable of taking in the image near the first joint of the finger; for instance, a rectangular shape in which the long side is 10 mm to 20 mm and the narrow side is 5 mm to 10 mm, and more preferably a rectangular shape in which the long side is 5 mm to 12 mm and the narrow side is 3 mm to 7 mm in order to further miniaturize the finger vein authentication apparatus. If the transmitted light intake port 20 is formed in the foregoing size, the size of the photographable area of the finger as the photographic subject will be 6 to 14 mm×10 to 24 mm.

The reason why the vein pattern near the first joint of the finger is effective for high-precision biometric identification is because the skin near the joint is thin and the veins are more likely transparent.

The small protrusion 18 may also be provided at a position where the fingertip is placed, in addition to the position of the first joint. Further, by positioning the finger so that it contacts a plurality of points, the presentation position of the finger will become stable. The small protrusion 18 may also be provided with a touch sensor. It will thereby be possible to detect that the finger has been firmly mounted on the case 10, and, in addition to the presentation position of the finger becoming stable each time, it will be possible to prevent the imaging of the finger vein in a state where the finger is detached from the apparatus.

Veins at the periphery of the second joint of the finger are also more transparent due to the same reason. Thus, it is also possible to perform authentication by diverting the small protrusion 18 for the positioning of the second joint. Nevertheless, if the positioning of the finger is made at the second joint, the finger will protrude significantly from the authentication apparatus toward the fingertip side, and a broader open space will be required on the fingertip side when installing the authentication apparatus. If the authentication apparatus is to be configured in a compact size or used in a compact manner, it would be more preferable to take an image of the first joint.

In substitute for the small protrusion 18, another designation means such as a symbol or a mark showing the position to which the first joint of the finger is to be placed may also be used.

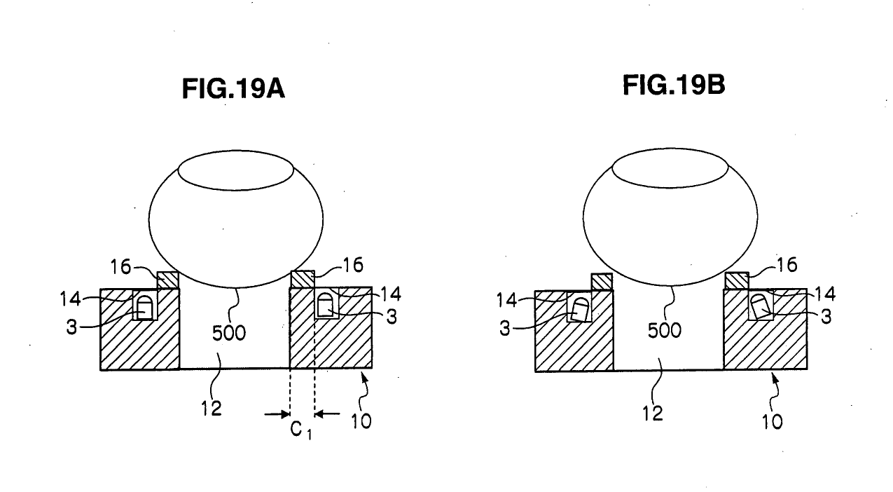

FIG. 19A is a cross section showing the mount position of the light source 3 on the case 10 when viewing the case 10 illustrated in FIG. 2 from the fingertip side. An infrared light source 3 is embedded inside the light irradiation port 14. For instance, an LED may be used as the light source 3. A lamp-type LED as shown in FIG. 19A may be used, or an LED having a planar top surface may be used.

The mount position of the light source 3 is now explained. The light source 3 is mounted on the bottom face side or the pulp side 500 of the finger. With a conventional finger vein authentication apparatus, since the light source was mounted on the upper side or the lateral side of the finger, it was necessary to extend the case to the upper side or lateral side of the finger in order to support the light source, and there was no choice but to increase the thickness of the apparatus. If the light source is mounted on the pulp side of the finger, the case can be formed thin since it is not necessary to extent the case to the upper side or lateral face of the finger. In addition, as described later, the present invention does not preclude mounting the light source 3 on the lateral side of the finger in order to alleviate the influence from wrinkles on the finger surface or the like.

The finger surface has numerous wrinkles of the fingerprint and joint. In order to improve the precision for authentication, a clear image of the veins must be taken while suppressing the influence of wrinkles. Thus, the light source is mounted on the case while giving consideration to the direction of the wrinkles so as to suppress the influence of such wrinkles.

For example, if the direction of the wrinkles is perpendicular to the longitudinal direction of the finger, the light source is mounted on the lateral face of the finger. The path of the light irradiated from the light source and the direction of the wrinkles will become parallel. Thus, since the light will reach the image sensor without colliding with the wall of the wrinkles, the image sensor is able to take images by limiting the influence of wrinkles.

Since many of the wrinkles in the periphery of the first joint of the finger are facing a direction that is perpendicular to the longitudinal direction of the finger, the light source is mounted on the lateral side of the finger.

In order to authenticate the finger veins, the image processor checks the luminance value of the respective pixels in the image, and extracts a vein pattern from the image by determining that the pixels having a lower luminance that the peripheral pixels to be the veins. In order to extract the vein pattern with high precision, it is important to irradiate light so that the light quantity will be uniform across the entire finger, and the image sensor to take an image with lower luminance non-uniformity. If there is any bias in the irradiation of light and only a part of the area is imaged darkly, that area may be erroneously extracted as a blood vessel during the image processing.

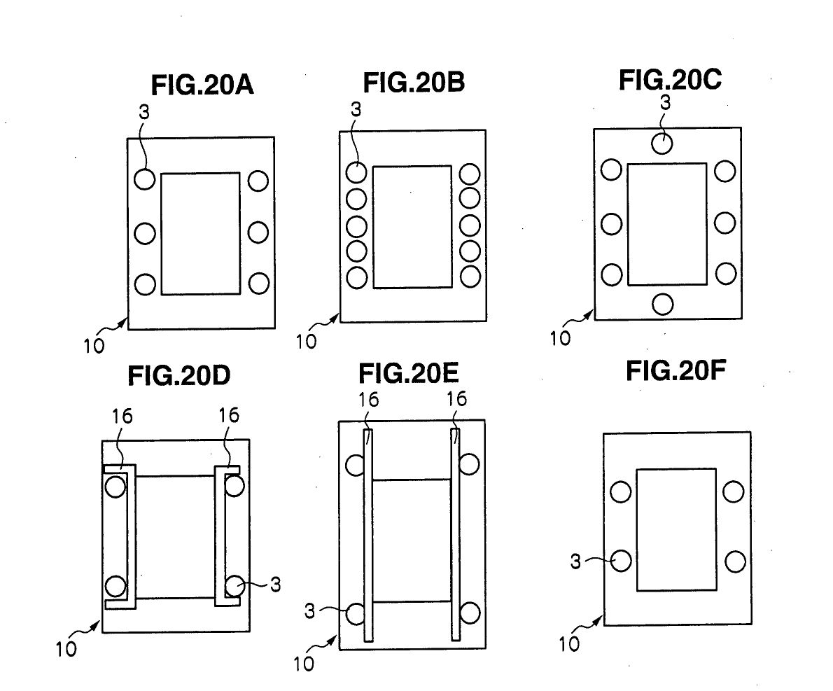

FIG. 20 shows examples of the arrangement of the light sources 3 and the light irradiation port 14 in the case for the vein authentication apparatus to obtain an image of low luminance non-uniformity. FIG. 20A to FIG. 20F are views showing a frame format of the planar surface of the case 10.

Although it would suffice so as long as a pair of light sources 3 is provided to either side of the case for irradiating the finger with sufficient brightness, in order to improve the image quality of the vein pattern image, it is desirable to arrange a plurality of pairs of light sources on the case along the longitudinal direction of the finger as shown in FIG. 20A and FIG. 20B.

In the foregoing case, preferably, the fingertip side to the finger base side is irradiated with a uniform brightness by evening spacing the light sources on either side of the case.

Moreover, preferably, the light quantity of the plurality of light sources provided on either side of the case is controlled independently. Further, if sufficient light does not reach the fingertip and finger base side with only the light sources on the lateral side of the finger, as shown in FIG. 20C, the light quantity to be irradiated on the finger can be supplemented by also providing light sources 3 to the fingertip and finger base side.

When arranging a plurality of light sources 3, it is not necessary to arrange all light sources 3 to be of perfect intervals, and, as shown in FIG. 20D to FIG. 20F, light sources may arranged at the fingertip and finger base side upon avoiding the center area of the case. This is because the skin of the first joint of the finger is thin and veins can be imaged with a lower light quantity in comparison to the other portions, and the light quantity can be made uniform for the overall finger image by irradiating strong light to portions other than the first joint, and irradiating slightly weak light to the first joint.

The mode for optimally arranging the light sources on the case will also change depending on the characteristics of the optical components used for the photography. In order to miniaturize the case of the finger vein authentication apparatus, it is effective to use a short focus lens unit. Nevertheless, a short focus lens has a drawback in that the sensitivity will deteriorate toward the periphery of the image. Thus, if an image of the finger is taken with this type of lens, the sensitivity will deteriorate in the areas that are farther away from the center of the image; that is, areas of the image of the fingertip side and finger base side.

Thus, as shown in FIG. 20D and FIG. 20E, the light sources 3 are arranged toward the front end and rear end of the case. When the finger is placed on the case with this configuration, light will be irradiated strongly from the light source to the lateral face of the fingertip side and the lateral face of the finger base side. Thus, the overall luminance of the taken image will become uniform.

If the light sources are arranged on the case at the fingertip side and base side as illustrated in FIG. 20D and FIG. 20E, the light irradiated from the light sources reach around to the pulp side of the fingertip and finger base.

As described above, in order to make the scattered light from the scattered substances 84 imperceptible in the photographed image, irradiation of light from the lateral face of the finger is effective, and it is necessary to inhibit the light from reaching around the pulp side of the fingertip and finger base.

Thus, the wall explained with reference to FIG. 1 is mounted in a U-shape on the case as shown in FIG. 20D, or mounted on the case so that the wall 16 is sufficiently longer along the longitudinal direction of the finger as shown in FIG. 20E. Light will thereby be primarily irradiated on the lateral face of the fingertip and finger base.

As depicted in FIG. 19A, the light source 3 is mounted on either side of the finger approximately perpendicular to the case 10. Since the finger is of a round shape when viewed from the fingertip side, if the light source 3 is mounted on the case at either side of the finger and irradiates light from the upper side of the case, the light will be blocked by the wall 16 and reach a high position of the finger. The contrast of the vein image will thereby increase.

Although FIG. 19A shows a case where the light source 3 exists on the outside of the contour of the finger, the light source 3 may be mounted on the case at a position that is inside the contour of the finger (side closer to the groove 12). The case width can thereby be reduced.

As described above, although it is preferable that the light source 3 is mounted on the case away from the groove 12 so as to inhibit the light from reaching around the bottom face of the finger, as a result of intense study, the present inventors discovered that that distance (C₁ of FIG. 19A) between the edge of the groove 12 and the light source 3 would suffice so as long as it is at least 2 mm.

The upper end of the light source 3 may also be inclined slightly toward the inside of the case as shown in FIG. 19B. Thereby, even if the finger is thin, the light source will be able to irradiate to the finger with sufficient light quantity for measurement. Moreover, a plurality of light sources 3 respectively having different inclination angles may be mounted on the case, and the light source 3 to be illuminated may be changed depending on the thickness of the finger. The angle of the light source may also be made to be controllable.

Returning to FIG. 1, fragments 22 protrude toward the center of the case from a pair of walls 16 at the approximate end on the fingertip side and the approximate end on the arm side of the case 10. FIG. 3 shows an example of the front view of the fragments 22 when viewing the case 10 along the longitudinal direction of the finger vein authentication apparatus pertaining to FIG. 1. In the example of FIG. 3, the fragment 22 has a tapered face 22a in which the height becomes lower toward the center of the case 10.

When the finger is mounted on the planar side of the case 10, the finger is guided toward the bottom face direction of the case according to the tapered faces 22A, and the finger will become attached more firmly to the case. It is thereby possible to prevent the outside light from entering into the imaging unit from a gap between the finger and the case 10.

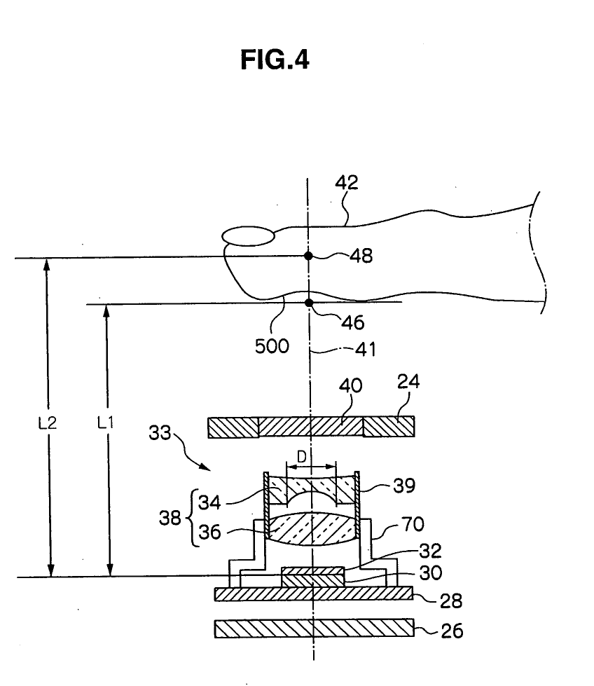

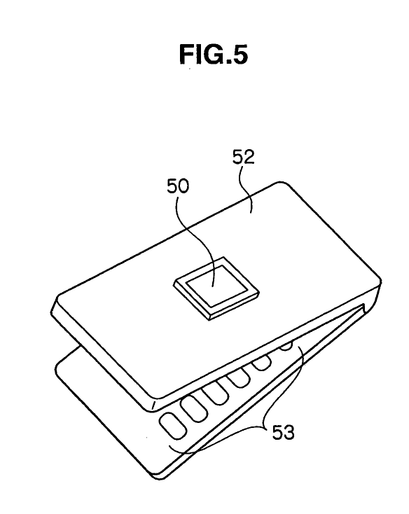

FIG. 4 is a schematic diagram showing an example of the positional relationship between the internal configuration of the finger vein authentication apparatus illustrated in FIG. 1, and the finger.

The lens apparatus 33 is used for imaging the transmitted light to the image sensor 30, and comprises a lens unit 38 configured from a first lens 34 on the finger side and a second lens 36 on the image sensor side that is supported by and fixed to a lens case 39. Reference numeral 32 shows a transparent layer for protecting the image sensor. The first lens 34 and the second lens 36 are housed in the lens case 39 so as to face each other along the optical axis 41.

The first lens 34 and the second lens 36 are micro diameter lenses wherein the effective diameter (D of FIG. 4) is approximately 2 mm or less, and preferably 1 mm to 1.5 mm. The first lens 34 is a concave lens having an overall negative power and formed in a concave shape on the facing the image sensor 30, and the second lens is a convex lens having an overall positive power and formed in a convex shape facing the finger and facing the image sensor 30.

The transmitted light intake port 20 formed on the bottom face 24 of the groove 12 is closed with the IR filter 40. Reference numeral 28 shows a substrate supported by the bottom face 26 of the case 10. An image sensor 30 configured from a CCD or a CMOS is fixed on the substrate 28, and a peripheral circuit of the image sensor 30 is also provided to the substrate 28.

The lens case 39 is formed in a hollow cylindrical shape for housing the lens unit 38. The lens case 39 is supported by the substrate 28 with a support member 70.

The lens unit 38 has a characteristic as a lens having a wide angle with a short focus by combining a concave lens and a convex lens. As a result, the lens unit can be moved closer to the finger as the photographic subject, and a wide-range image can be loaded into the image sensor even if the lens unit is moved closer to the finger.

Thereby, the distance (conjugate distance) L1 between the finger bottom 46 and the image sensor 30 can be reduced, and, based on tests conducted by the present inventors, it has been discovered that the conjugate distance can be set within a range of 5.0 mm to 12.0 mm. Thus, the thickness of the case 10 can be reduced. Consequently, for instance, even when mounting the finger vein authentication apparatus 50 on one case 52 of a foldable mobile phone as shown in FIG. 5, it is possible to inhibit the enlargement of the mobile phone.

In order to make the conjugate distance an even smaller value, it is necessary to use a lens with a high refractive index. Contrarily, however, the object-side field angle will increase, and it will become difficult to load the vein image to the extent necessary for authentication into the mage sensor 30. Thus, the conjugate distance is set to be 5.0 mm or greater. If the field angle can be expanded by improving the material or shape of the lens, it is not necessary to limit the lower limit of the conjugate distance to 5 mm.

In order to apply a biometric authentication apparatus to portable electronic apparatuses such as mobile phones, electronic notebooks, and electronic cards such as smart keys which are demanded of the thinnest possible thickness, the conjugate distance is preferably set to 8.0 mm or less.

Incidentally, FIG. 5 is merely an example, and the finger vein authentication apparatus 50 may also be mounted on the other case equipped with a key operation unit 53.

In FIG. 4, reference numeral 48 shows the perfect focus position, and reference numeral L2 shows the perfect focus length between the perfect focus position in the finger and the image sensor 30. The lens apparatus 33 is moved forward or backward in relation to the image sensor 30 so that the perfect focus position 48 is positioned within the finger, and the distance between the lens unit 38 and the image sensor 30 is adjusted thereby.

Even if the distance (conjugate distance) L1 between the finger bottom 46 and the image sensor 30 is reduced, since the perfect focus position can be set to be within the finger, the image sensor 30 is able to create an image corresponding to the vein pattern in the finger.

As described above, although the optical characteristics of the lens unit was explained as short focus and wide angle, preferably, the focal distance thereof is 0.15 mm or greater and 0.5 mm or less, and more preferably 0.15 mm or greater and 0.20 mm or less, and the object-side maximum field angle thereof is 100° or greater. If the focal distance is less than 0.15 mm, it is difficult to manufacture the lens unit, and if the focal distance exceeds 0.5 mm, it is not possible to make the distance L1 of FIG. 4 to be a sufficiently small value.

Moreover, if the object-side maximum field angle is 100° or greater, a vein pattern that is within the range of 10 mm in the vicinity of the first joint of the finger can be acquired. In order to perform vein authentication with precision, it is desirable to acquire a vein pattern in the foregoing range.

Moreover, the lens unit has a paraxial magnification of 0.04 or greater and 0.1 or less, and preferably 0.04 or greater and 0.06 or less. If the paraxial magnification is less than 0.04, the resolution will deteriorate, and if the paraxial magnification exceeds 0.1, there is a possibility that the photograph area required for vein pattern authentication cannot be secured.

If a short focus wide angle lens unit is used, while the authentication apparatus can be miniaturized in the height direction thereof on the one hand, the image obtained with the image sensor 30 will become strained, and there is a possibility that the vein pattern cannot be accurately extracted from the image.

Thus, the vein authentication apparatus comprises an image processing function/means for correcting the strain of the image. As a result of the present inventors conducting detailed tests upon variously changing the characteristics of the lens unit, it has been confirmed that the strain of the image can be corrected so as long as the optical strain of the image is within the range of −60% to +50%.

As a result of intense study, the present inventors discovered that if the focal distance of the lens unit is set to be 0.15 mm or greater and 0.20 mm or less, it is possible to inhibit the optical strain of the lens unit to be within the range of −2% to +50%, and the strain of the image can thereby be corrected with higher precision.

In the example of FIG. 4, although the lens unit 39 is configured from two lenses, the configuration is not limited thereto, and the lens unit may be configured from one lens or three or more lenses so as long as it possessed the demanded lens characteristics.

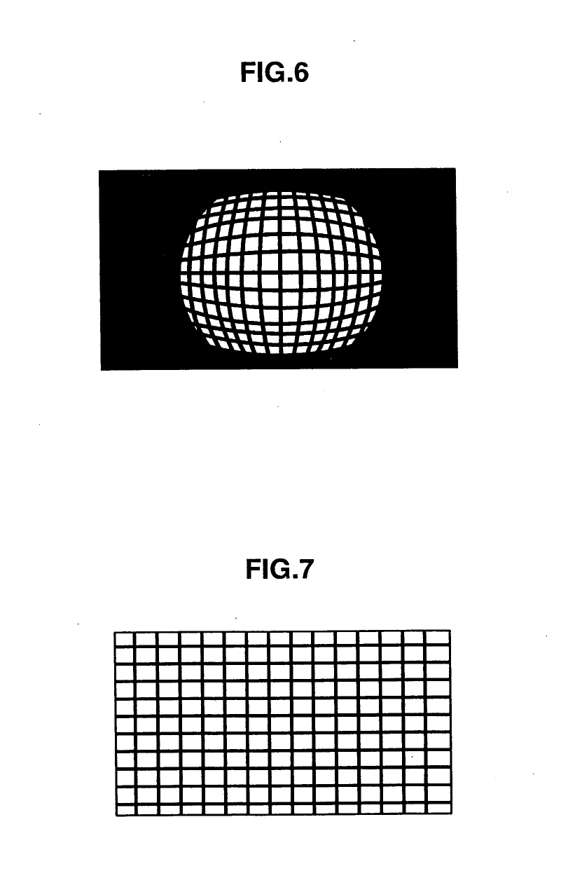

FIG. 6 is an image before correction obtained with the image sensor 30, and FIG. 7 shows an example of the image after the strain is corrected. The image of FIG. 6 was obtained by mounting a reference printed material, on which was printed an image of a grid-shaped pattern in 1 mm intervals, on the planar side of the case 10 illustrated in FIG. 1, and taking an image thereof with the image sensor 30. If the strain is corrected, the image in which the shape was strained toward the periphery as shown in FIG. 6 is corrected to the image of roughly an even grid shape as shown in FIG. 7. The control method of correcting the strain will be described later.

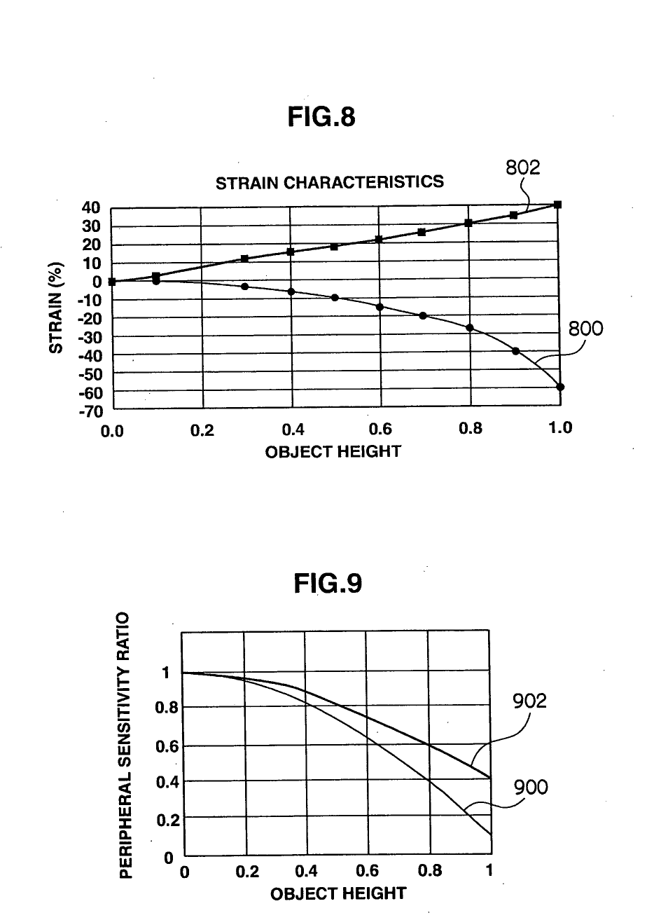

FIG. 8 is a graph showing the strain characteristics. The object height shown in FIG. 8 refers to the relative position from the center point (optical axis: 41 of FIG. 4) of the image to the end of the image, and, for instance, the object height being “1.0” represents the position at the farthest point of the image, and the object height being “0.6” represents the position that is 60% from the center point (40% from the end).

In FIG. 8, reference numeral 800 shows the characteristics of the first lens unit, and reference numeral 802 shows the characteristics of the second lens unit. The strain characteristics being in the minus means that the pixels are strained toward the center side of the image, and the strain characteristics being in the plus means that the pixels are straining in a direction that moves away from the center of the image.

The strain (%) is a value corresponding to “T/S” in relation to the original position (distance “T” from the center) of the pixels and the position of pixels (distance “S” from the center) after the strain. As a result of intense study, the present inventors discovered that the resolution deteriorates suddenly at the peripheral portion if the optical strain greater on the minus side than −60%, and the image cannot be completely recovered even when performing the image strain correction described later.

Moreover, if the optical strain exceeds +50%, it is necessary to process the image in a wide range, and it has been discovered that there is problem in terms of processing time. Thus, so as long as the strain is restricted to be between the first characteristic (800) and the second characteristic (802); that is, so as long as the optical strain is within the range of −60% and +50%, the strain can be corrected with the image processor.

As the lens unit characteristics, it is further preferable that the sensitivity ratio at the object-side maximum field angle is 10% or greater and 65% or less, and more preferably 40% or greater and 65% or less. With a short focus, wide angle lens unit, as shown in FIG. 9, the sensitivity deteriorates toward the periphery of the image.

In FIG. 9, reference numeral 900 shows the sensitivity ratio characteristics of the first lens unit, and reference numeral 902 shows the sensitivity ratio characteristics of the second lens unit. For example, the sensitivity ratio being “0.4” shows that the luminance is 40% assuming that the luminance at the center of the image is “1.0.” The deterioration of sensitivity in a short focus, wide angle lens unit, as shown in FIG. 1, can be compensated by arranging the exit port of the light at the peripheral area of the case 10, and irradiating light from the lateral face of the finger. The sensitivity ratio can also be referred to as the luminance ratio.

If the sensitivity ratio is less than 10%, the luminance at the periphery of the image will deteriorate, and it will not be possible to obtain an accurate image of the vein pattern with the image sensor. Meanwhile, if the sensitivity ratio exceeds 65%, the luminance at the periphery of the image will increase, and, similarly, it will not be possible to obtain an accurate image of vein pattern with the image sensor. As a result of intense study, the present inventors confirmed that, so as long as the sensitivity ratio at the object-side maximum field angle (object height is “1.0”) is between the characteristics (900) of the first lens unit and the characteristics (902) of the second lens unit; that is, so as long as the sensitivity ratio is within the range of 10% or greater and 40% or less, the deterioration of sensitivity can be compensated.

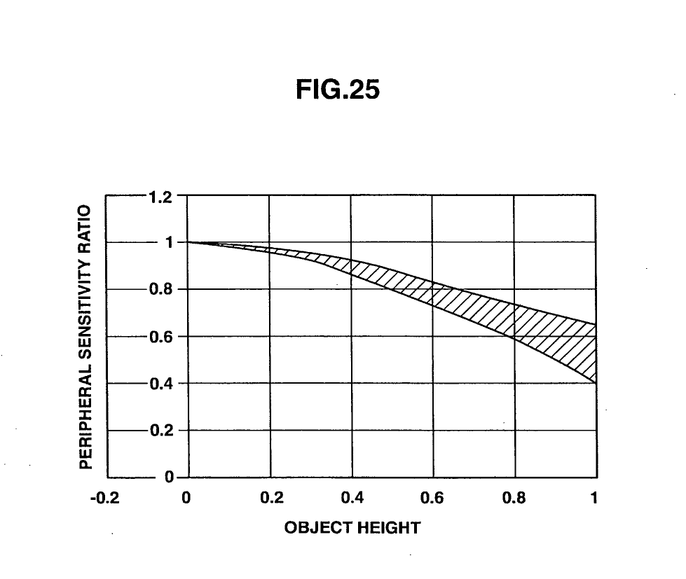

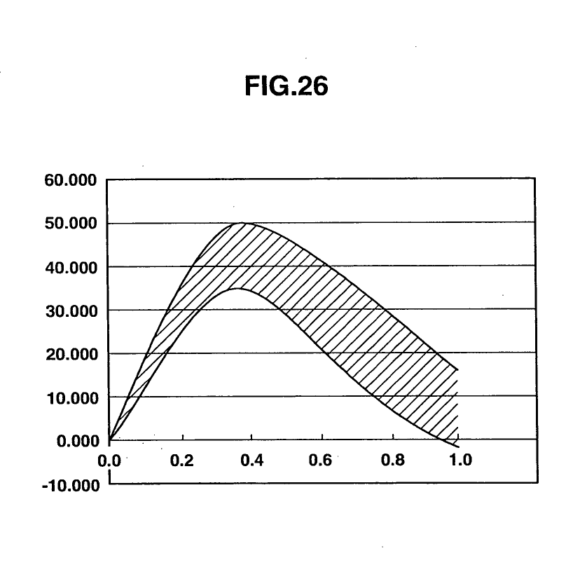

As a result of additional study, the present inventors examined the sensitivity ratio by configuring a lens unit with various combinations of a plurality of lenses such that the focal distance is 0.15 mm or greater and 0.2 mm or less, the object-side maximum field angle is 100°, the paraxial magnification is 0.04 or greater and 0.06 or less, and the size of the finger authentication area is 10 mm in the width direction and 15 mm to 18 mm in the length direction of the finger, and, as shown in FIG. 25, confirmed that the sensitivity ratio at the object-side maximum field angle can be made to be 40% or greater and 65% or less. Moreover, as shown in FIG. 26, as a result of examining the relationship between the object height and the optical strain, it was possible to inhibit the optical strain to be within a range of −2% to +50%.

As described above, in order to make the conjugate distance 5.0 mm or greater and 8.0 mm or less, a short focus lens unit having a focal distance of 0.15 mm or greater and 0.20 mm or less is used. Meanwhile, if there is any deterioration in the optical strain and the sensitivity ratio, there is a possibility that the image strain cannot be corrected, or the vein image cannot be acquired accurately.

Thus, the foregoing drawback can be overcome by configuring the lens unit such that the optical strain of the lens unit is −2% to +50%, the paraxial magnification is 0.04 or greater and 0.06 or less, and the sensitivity ratio at the object-side maximum field angle is 40% or greater and 65% or less.

Like this, the image sensor 30 is able to load a vein pattern in the finger with high precision even from an area of the object-side maximum field angle of the lens unit.

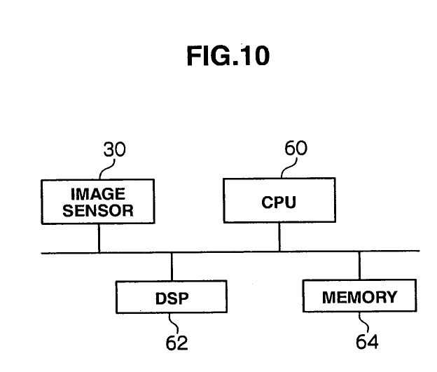

The image processing and authentication function of the finger vein authentication apparatus are now explained. FIG. 10 is a block diagram showing a configuration example concerning the image processor of the finger vein authentication apparatus. The image processor comprises a pattern extractor for extracting the vein pattern of the finger from the image taken with the image sensor, and an image corrector for correcting the strain of the image.

The CPU (Central Processing Unit) 60 starts the image processing program recorded in the memory 64 based on the user's operation, and commands the DSP (Digital Signal Processor) 62 to load an image from the image sensor 30. The CPU 60 loads the luminance data of the respective pixels of the image sensor 30 from the DSP 62, and thereby determines whether a finger is mounted on the case 10.

If the finger is not mounted on the case 10, the outside light will reach the image sensor 30, the luminance of the pixels will increase beyond a prescribed value, and the CPU 60 will determine that a finger is not mounted on the case 10.

If the CPU 60 determines that a finger is mounted on the case 10, it checks the luminance of the respective pixels of the image obtained with the image sensor 30, and individually controls the light quantity emitted from a plurality of irradiation ports 14 so that the luminance is uniform in the respective pixels. Specifically, [the CPU 60] controls the drive signals supplied to the respective light sources arranged in correspondence to the respective irradiation ports 14 for correcting the amount of luminescence of the light source, and thereby controls the light quantity emitted from the irradiation port 14.

The light quantity control is described in detail below. Since the appropriate light quantity differs depending on the width or thickness of the finger presented to the finger vein authentication apparatus, it is necessary to adjust the light quantity of the light source for each characteristic of the finger in order to take a clear finger vein image.

For example, if the thickness of the finger is thin, since the luminance tends to become higher in comparison to a thick finger, the light quantity is reduced. Moreover, if the width of the finger is narrow, in comparison to a finger with the wide width, since the distance from the light irradiation port to the finger will become far, it is difficult for the light to reach. In order to irradiate a sufficient amount of light on the finger, it is necessary to increase the light quantity to be emitted from the light irradiation port 14.

In addition, even if it is the same finger, since the width at the fingertip side and the width at the finger base side are different, the appropriate light quantity value will differ. Thus, the light quantity value of the fingertip side and the light quantity value of the finger base side are independently controlled. Or, by utilizing the feature of a finger where the fingertip narrows and the finger base becomes thicker, it is possible to adjust the light quantity in advance so that the light quantity of the fingertip side becomes stronger, and simultaneously control the light quantity of the fingertip side and the light quantity of the finger base side.

When there is no choice but to irradiate the same light quantity from the respective light sources on the finger, the light source should be positioned closer toward the fingertip, and farther away toward the base side. It is also preferable to independently control the left-and-right light quantity values in consideration of the lateral asymmetric nature of the finger shape and the lateral position upon mounting the finger on the case. The CPU 60 determines the lateral asymmetric nature of the finger shape, displacement in the lateral direction of the finger, and the thickness of the finger based on the fact that the luminance between the plurality of pixels is not uniform, and independently controls the light source of the left-and-right lateral sides and base side of the finger.

When the CPU 60 determines that the correction of light quantity is complete, it commands the DSP 62 to perform strain correction to the image taken with the image sensor 30. The strain correction is performed according to the operation based on the foregoing strain characteristics. Thus, before shipping the finger vein authentication apparatus, the strain characteristics of the lens unit 38 are sought in advance and stored in the memory 64. The DSP 62 refers to such strain characteristics and performs strain correction regarding the respective pixels of the image obtained with the image sensor 30.

If the strain is X %, a correction value (100/X) is multiplied to the pixels to be corrected in the image, and the pixel position in relation to the center (optical axis) of the image is corrected based on the operational result. If the strain is in the plus, the pixel position is corrected toward the optical axis side, and if the strain is in the minus, the pixel position is corrected in a direction that moves away from the optical axis. Thereby, for instance, it is possible to correct the strained image as shown in FIG. 6 and FIG. 7.

The CPU 60 stores the image after strain correction in the memory 64, and the CPU 60 determines the shading regarding the respective pixels of the monochrome image after correction, and extracts the vein patter from the image after correction (extraction of characteristic point).

While the near-infrared light irradiated from the light source to the finger is absorbed in the hemoglobin in the veins on the one hand, it scatters in various directions due to the other tissues, and the transmitted light corresponding to the vein pattern thereby reaches the image sensor 30 via the lens unit 38. Since the transmitted light is absorbed and becomes weak in the pixel area corresponding to the vein pattern, a monochrome image in which the area corresponding to the vein pattern is dark is obtained with the image sensor 30.

The CPU 60 detects the vein pattern from the monochrome image, and performs biometric authentication using the detected vein pattern. Specifically, the vein pattern extracted with the finger vein authentication apparatus is registered in the memory 64, and the personal authentication of the user is decided by determining whether the registered vein pattern and the newly extracted vein pattern coincide, or are inconsistent.

If the finger vein authentication apparatus is mounted on an information processing apparatus such as a mobile phone, or connected to an external apparatus via a wire or wireless, the CPU 60 notifies the result of the personal authentication to the information processing apparatus or the external apparatus, and the information processing apparatus uses this notice to provide various services such as e-commerce and online banking to the user.

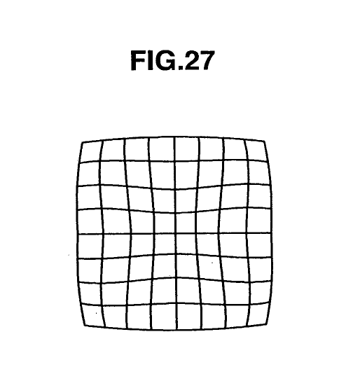

FIG. 27 is an image obtained with the image sensor under the same conditions as FIG. 6 using a short focus lens unit in which the focal distance is 0.15 mm or greater and 0.20 mm or less, the optical strain is −2% to +50%, the paraxial magnification is 0.04 or greater and 0.06 or less, the sensitivity ratio at the object-side maximum field angle is 40% or greater and the conjugate distance is 8 mm or less. As evident from FIG. 27, since the image is strained around the center of the image obtained with the image sensor 30, the image processor corrects this strain so that it is eliminated.

In connection with the image processor performing correction processing to the image, the present inventors acquired an image of a reference print with the image sensor, and loaded the acquired image in the image processing program. Subsequently, the respective correction values described above regarding all pixels of the image before correction were decided using the image processing program, and such values were stored as a parameter in the memory.

If there is a difference in the size or characteristics of the lens unit, or a difference in the size of the case 10 (size of the transmitted light intake port 20 of the groove 12), a parameter is decided regarding each mode. The decided parameter is set and stored in the memory 64 of the image processor in advance. The DSP 62 reads the parameter from the memory 64 and then corrects the image.

In the foregoing explanation, although the characteristic point extraction processing was performed after performing the strain correction, strain correction may be performed after extracting the vein pattern from the image based on the characteristic point extraction processing.

In the foregoing case, there is an advantage in that the processing time required by the DSP 62 to perform the strain correction can be reduced since the number of pixels to be subject to strain correction can be limited to the number of pixels corresponding to the vein pattern. In comparison to a case of performing strain correction regarding all pixels, the number of pixels that need to be corrected can be reduced ⅛ by performing the strain correction after extracting the characteristic points.

Although the example illustrated in FIG. 10 shows an example where the CPU 60, the DSP 62 and the memory 64 are configured separately, the configuration is not limited thereto, and one or all of these components may be configured as a single processing unit.

When mounting the finger vein authentication apparatus on an information processing apparatus such as a mobile phone, in substitute for providing a CPU 60 and the like in the authentication apparatus, the CPU of the information processing apparatus can be used for performing the image processing and authentication.

In addition, a part or the entirety of the image processing and authentication function can be moved from the information processing apparatus to the server side. Further, in substitute of storing the vein pattern data in the finger vein authentication apparatus or the information processing apparatus, the pattern data may also be registered in the server. When registering the vein pattern in the finger vein authentication apparatus or the information processing apparatus, the vein pattern is encrypted then registered to prevent a third party from reading such vein pattern.

The embodiment of applying the finger vein authentication apparatus to a mobile phone is now explained in detail. With the finger vein authentication apparatus described above, since the distance between the finger bottom and the image sensor can be shortened, the finger vein authentication apparatus can be mounted on an information processing apparatus even if it is compact information processing apparatus such as a mobile phone while inhibiting the enlargement of the apparatus.

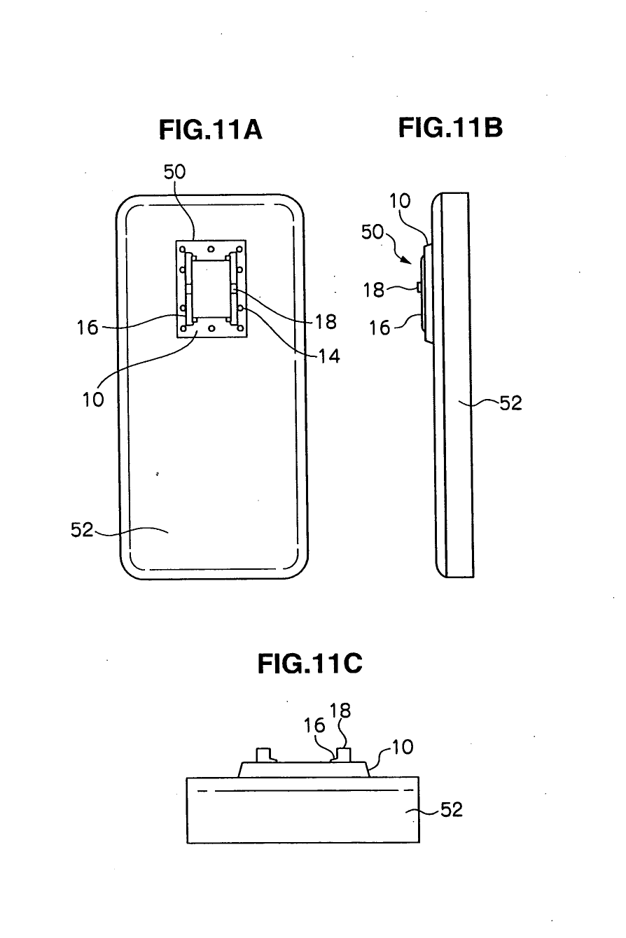

FIG. 11A is a plan view of the mobile phone case 52, FIG. 11B is a right side view thereof, and FIG. 11C is a front view thereof. In this example, the vein authentication apparatus 50 is mounted toward the hinge of the mobile phone. In order to allow the user to become more easily aware of the vein authentication apparatus 50, the case 10 of the vein authentication apparatus 50 is slightly protruding from the mobile phone case 52.

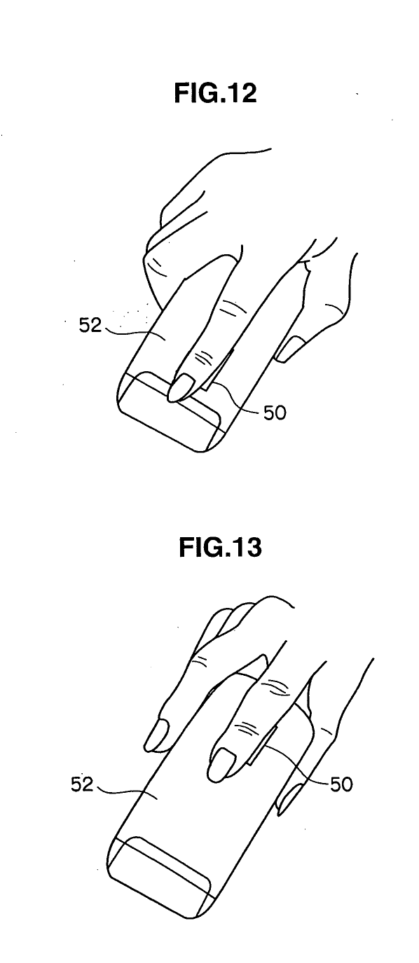

As shown in FIG. 12, the user is able to place the vicinity of the first joint of one's index finger on the vein authentication apparatus 50 while holding the mobile phone with one hand. In order to enable the user to place the vicinity of the first joint of one's finger to be authenticated on the vein authentication apparatus while stably holding the mobile phone 50 with one hand, it is preferable to provide the tip of the vein authentication apparatus 50 at a position that is roughly 3 cm from the tip end of the mobile phone.

Further, as shown in FIG. 13, the vein authentication apparatus 50 may also be provided toward the open end of the mobile phone. In this case, the base end of the authentication apparatus should be provided at a position that is roughly 3 cm, which roughly corresponds to the distance between the fingertip and the first join, from the open end of the mobile phone. As a result of the foregoing positional placement, when a finger is mounted on the vein authentication apparatus 50, the second joint of the finger will bend naturally and moderately, and the finger is prevented from pressing too hard on the vein authentication apparatus 50.

In the examples shown in FIG. 5 and FIG. 11, although the finger vein authentication apparatus is provided to the planar surface of the mobile phone case 52, the configuration is not limited thereto, and, so as long as it is the surface of the case 52, the finger vein authentication apparatus can also be provided on the lateral face.

Although a case of mounting the finger vein authentication apparatus on a mobile phone was described above, the target of applying the finger vein authentication apparatus is not limited to a mobile phone, and, needless to say, the finger vein authentication apparatus can also be applied to various information processing apparatuses such as a PDA, laptop computer and the like. The information processing apparatus is not limited to the above, the finger vein authentication apparatus according to the present invention can also be mounted on cars and entrance/exit management apparatuses.

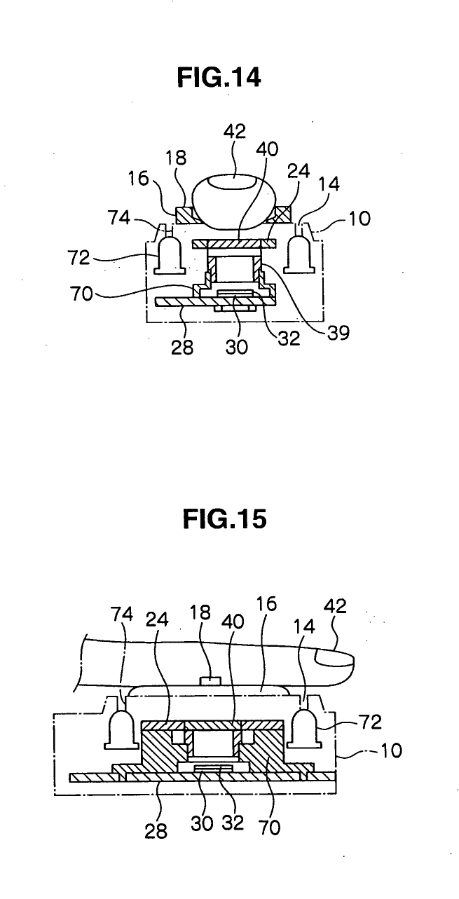

FIG. 14 is an example of the A-A cross section of FIG. 1, and FIG. 15 is an example of the B-B cross section thereof. FIG. 14 and FIG. 15 show the appearance where the finger vein authentication apparatus is integrally stored in the mobile phone 52. In other words, the case 10 doubles as the mobile phone case. Incidentally, the same reference numerals as used in the foregoing drawings represent the same components, and the explanation thereof is omitted.

An LED 72 as the light source is embedded in the case of the mobile phone 52. A through hole 74 is formed in the case 10 from the vertex of the LED 72 in a direction that is perpendicular to the width direction of the LED, and this through hole 74 is connected to an irradiation port 14. The near-infrared light emitted from the LED 72 passes through the through hole 74 and advances from the irradiation port 14 toward the finger. Since a wall 16 is provided along the longitudinal direction of the finger in the vicinity of the finger bottom, the light irradiated from the LED 72 crosses the wall 16 and enters the finger from the lateral face of the finger.

The light that entered from the lateral face of the finger scatters inside the finger, partially passes through the veins and reaches the image sensor 30, and the lens unit 38 forms an image corresponding to the vein pattern from the transmitted light in the image sensor 30.

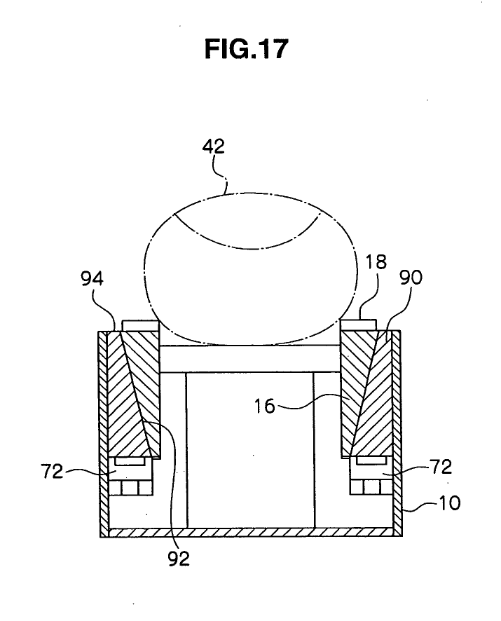

FIG. 17 shows another example of the internal configuration of the finger vein authentication apparatus. In the example of FIG. 14, the center of the irradiation port 14 and the center of the LED 72 are arranged to roughly coincide so that the light from the irradiation port 14 is emitted efficiently. Since the irradiation port 14 is provided outside the wall 16, the width of the finger vein authentication apparatus will become wide if the LED 72 is arranged together with the center of the irradiation port 14.

Meanwhile, in the example shown in FIG. 17, the width is narrowed by providing a light guide 90 for guiding the light generated from the LED 72 to the irradiation port 14.

The light guide 90 comprises a tapered face 92 that tapers toward the outer periphery of the case 10 as it nears the irradiation port 14. The emitted light that entered the bottom face of the light guide 90 from the LED 72 is guided along the tapered face 92, and emitted from the irradiation port 14 toward the lateral face of the finger.

Thereby, since it is possible to provide the center of the LED 72 farther inside than the center of the irradiation port 14 while efficiently emitting light from the irradiation port 14, the width of the finger vein authentication apparatus can be narrowed.

Further, the light guide 90 may be provided for each LED 72 arranged in correspondence with the respective irradiation ports 14, or one light guide may be provided to each of the plurality of LEDs 72 arranged on the left side and the right side.

When providing one light guide on the left side and the right side, respectively, one rectangular or oval irradiation port may be provided respectively along the wall 16 in substitute for comprising a plurality of irradiation ports. By providing this kind of irradiation port, the light guide can be shared by a plurality of LEDs, and light can be uniformly irradiated to the lateral face of the finger. In addition to the lateral direction, an irradiation port in the shape of a rectangle or the like may be provided in the vertical direction.

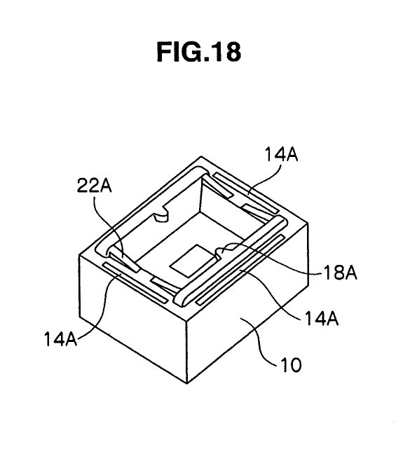

FIG. 18 shows an example where a rectangular irradiation port 14A is provided in both the lateral and vertical directions of the case 10. This example is configured such that the protrusion 18A for designating the mount position of the first joint of the finger protrudes toward the inside of the width direction of the case 10, and the tapered face of the fragment 22A for guiding the finger toward the groove side is formed in an R-shape to match the peripheral shape of the finger.

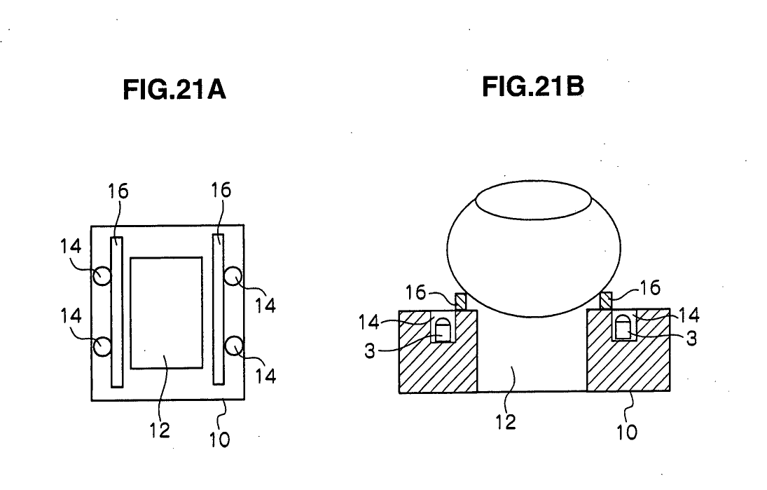

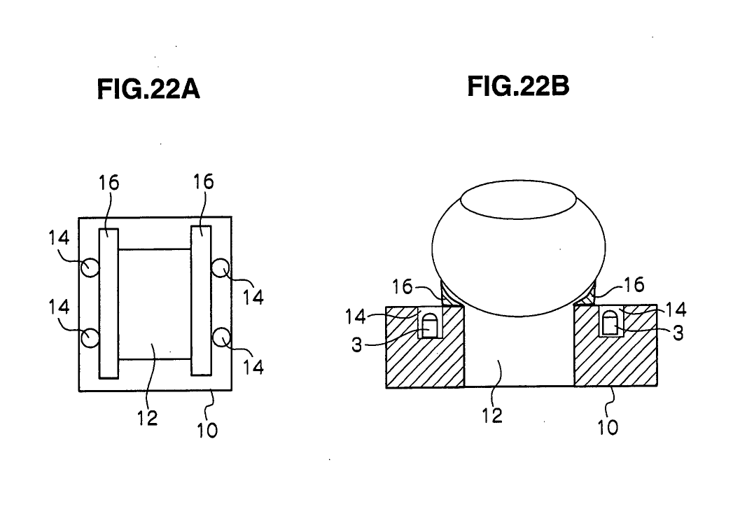

The shape of the foregoing wall 16 is now explained in detail. FIG. 19A is a view from the fingertip side of the authentication apparatus illustrated in FIG. 1. FIG. 21 and FIG. 22 show other modes of the wall 16.

As shown in FIG. 19A, the width of the wall 16 is roughly the same as the distance between the inside edge of the case of the light irradiation port 14 and the outside edge of the case of the groove 16. As shown in FIG. 21, the wall 16 may also be mounted on the case closer to the light irradiation port 12 to make the width narrower than FIG. 19A. Thereby, the fulcrum for supporting the finger will move outside the finger, and the finger can be placed at a position that is lower than the case. Thus, the height of the wall 16 in relation to the finger will become relatively high, and the light source 3 will irradiate light only on the high position of the finger.

The wall 16 may also be formed in an R-shape to match the peripheral shape of the finger as shown in FIG. 22. Thereby, since the area where the finger and the wall 16 will contact will increase, the wall 16 can more effectively block the light from reaching around the bottom face of the finger. The wall 16 is able to stably support the finger on the case since it matches the shape of the lateral face of the finger.

The light source 3 is mounted on the case so that the upper end of the light source 3 becomes the same height or slightly lower than the planar position of the case 10 in order to prevent the light source from protruding from the planar face of the case.

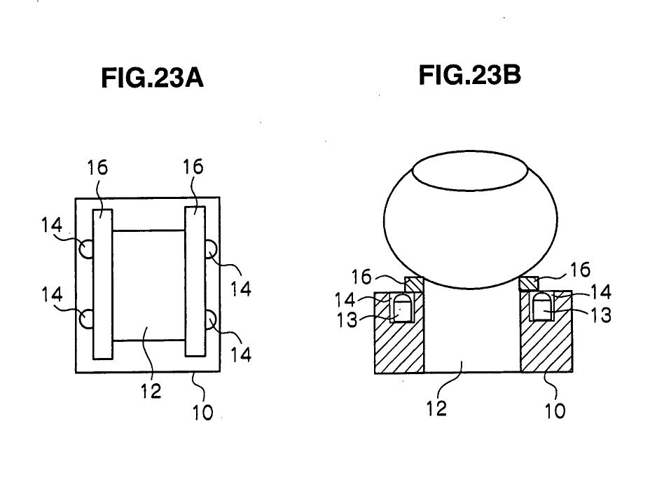

If sufficient light quantity can be irradiated from the light source to the finger, a part of the upper end of the light source 3 may be covered with by wall 16 or the case 10. For example, as shown in FIG. 23, if the light source 3 is arranged such that a part thereof is hidden under the wall 16, the light source 3 can be mounted closer to the inside of the apparatus (groove 12 side). The width of the authentication apparatus can thereby be shortened.

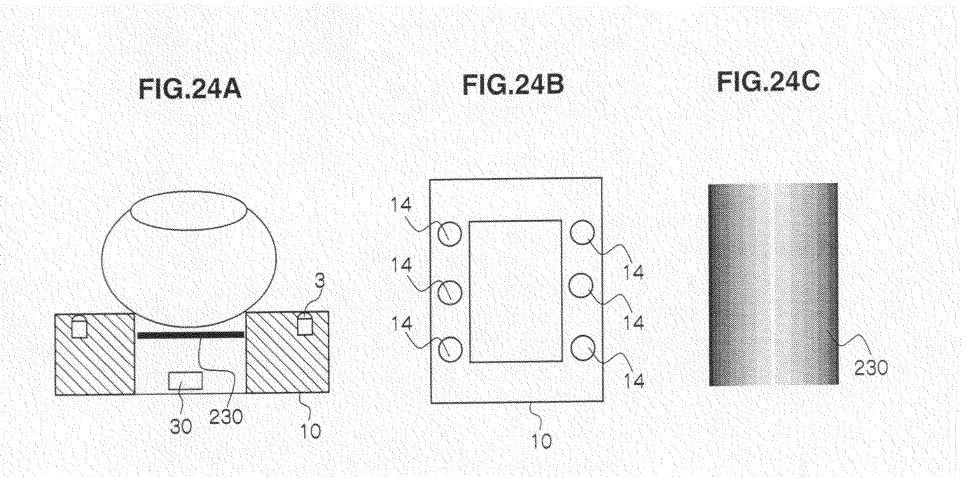

FIG. 24 shows a finger vein authentication apparatus in which a filter 230 having a different fading rate of light depending on the area is mounted on the case. FIG. 24A is a cross section of the apparatus, and FIG. 24B is a plan view thereof. FIG. 24C is the filter 230. The area with a deeper color of the filter has a higher fading rate of light, and the area with a lighter color has a lower fading rate of light.

If veins are photographed with an authentication apparatus in which the light source is provided to the lateral side of the finger as shown in FIG. 24B, the photographed image will have a higher luminance value in the area that is closer to the light source, and a lower luminance value in the center area of the image. Thus, the filter 230 is mounted between the finger and the image sensor 30 as shown in FIG. 24A. Thereby, the amount of light that reaches the image sensor 30 will become uniform at the lateral area and the center area of the finger, and a vein image having a uniform brightness across the entire image can be taken. Moreover, instead of mounting the filter 230, the image processor may control the sensitivity such as the gain or shutter speed per pixel in the image sensor 30. By lowering the sensitivity of pixels on the light source side and increasing the sensitivity of pixels at the center, the same effect as mounting the filter 230 can be expected.

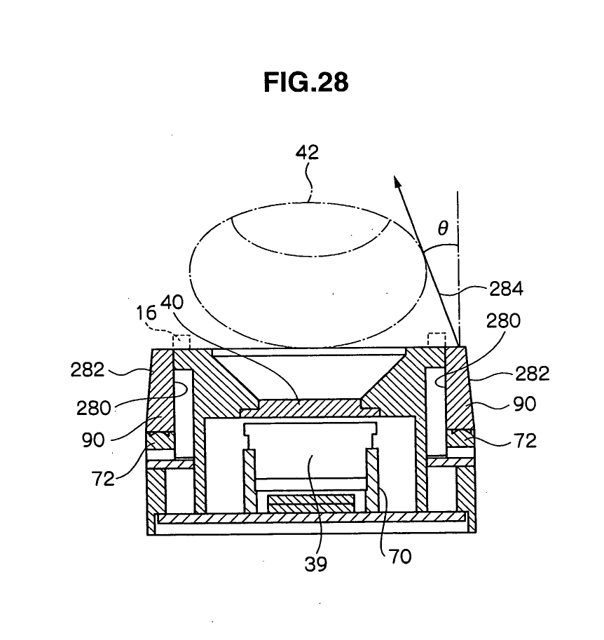

A finger vein authentication apparatus comprising a light guide having a different mode than the light guide of the foregoing embodiment is now explained. With this light guide, as shown in FIG. 28, an apparatus-side side face 280 of the light guide 90 is placed along the direction of gravitational force, and a lateral face 282 on the side facing the foregoing lateral face is tapered toward the upper direction of the apparatus side in relation to the direction of gravitational force.

By forming the light guide in this kind of shape, the direction of the beam emitted from the light guide can be directed toward the lateral face of the finger, and, preferably, the direction of the beam can be made to be a tangential direction in relation to the finger 24 as shown in FIG. 28.

As a result of intense study, the present inventors discovered that, when considering that the finger size of an average person is 14 mm in diameter, if light having an angle (θ) of roughly 18° to 28° from the light guide is emitted to the lateral face of the finger in relation to the direction of gravitational force, it is possible to obtain an extremely favorable image where the luminance level is uniform across the entire screen.

By configuring the light guide as described above, it is possible to guide the light from the light source 72 to the lateral face of the finger 42 without having to use the wall 16. Thus, since the foregoing wall 16 can be omitted from the case 10 or height of the wall 16 can be lowered, the thickness of the case can also be reduced accordingly. As shown with the dotted line in FIG. 28, a low wall 16 may be mounted closer to the finger side (central axis side of the case 10) than the light guide 90 (refer to FIG. 17).

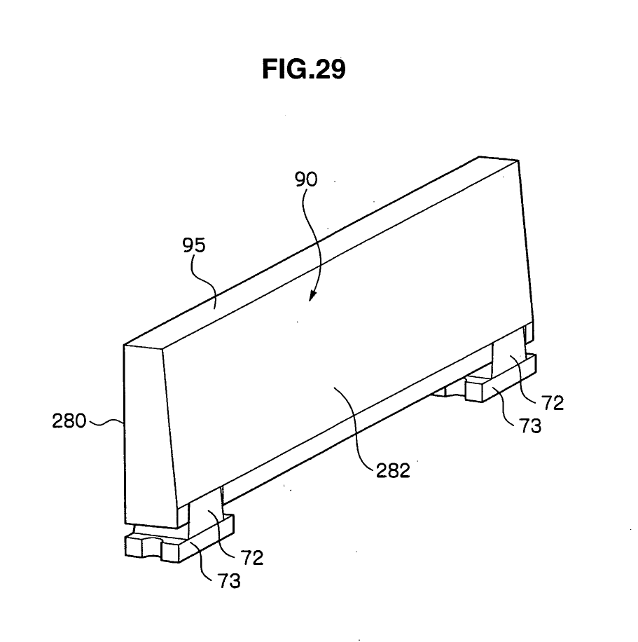

FIG. 29 to FIG. 31 show perspective views of the overall light guide. The light guide 90 is configured in a panel shape along the length direction of the case 10. Reference numeral 72 shows an LED as the light source to be mounted on the lower end of the light guide, and reference numeral 73 is a control board of the LED 72. A total of two LEDs are provided at the ends in the length direction of the light guide.

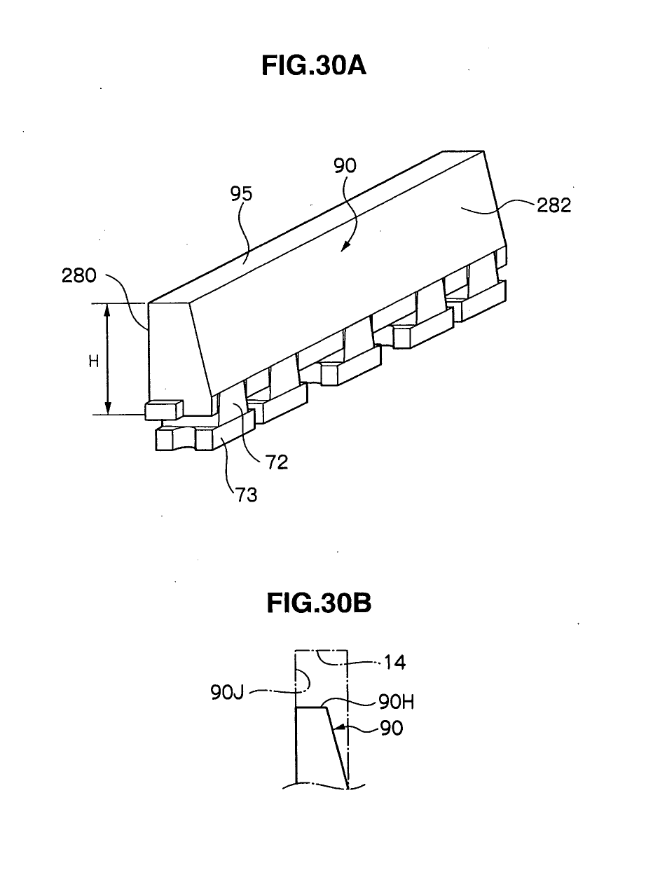

FIG. 30A is a perspective view showing another example of a light guide, and five LED light sources are mounted along the length direction of the light guide. If the number of LEDs 72 is increased, a favorable image having a uniform luminance level across the entire screen can be obtained. Although there is no particular limitation on the number of LEDs 72, fewer the better from the perspective of power consumption. Incidentally, as shown in FIG. 30B, the height H of the light guide may be shorter than the height of the groove 90J of the case 10 that houses the light guide, and the terminal face 90F of the light guide may end lower than the light exit port 14.

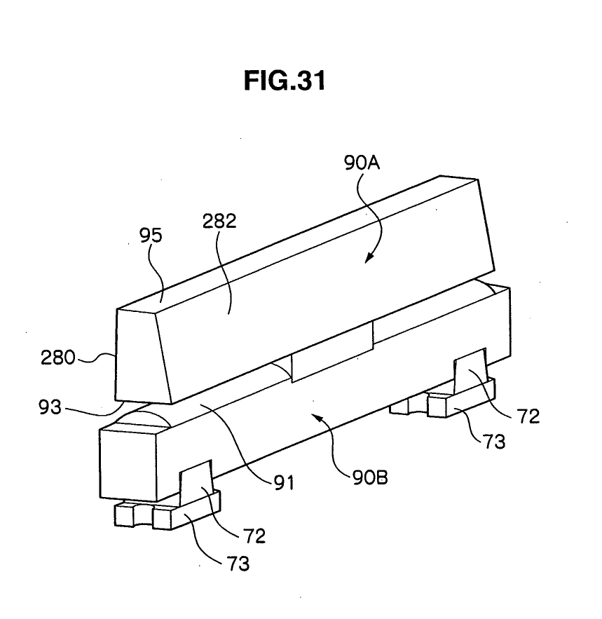

FIG. 31 is a perspective view showing yet another example of the light guide, and shows that the light guide was divided in halves in the thickness direction of the case.

In a structure where the light guide is divided into halves as described above, by slightly separating the two end faces of the two light guides (90A. 90B) at the divided portion, and forming the end face 91 of the first light guide 90B to which light from the LED is foremost supplied in spherical shape or a non-spherical shape in relation to the end face 93 of the second light guide 90A, the light supplied from the LED 72 to the first light guide 90B can be converted into parallel light and guided to the second light guide 90A. Thereby, the direction of the light emitted from the second light guide 90A can be guided to the lateral face of the finger even more dominantly.

Although the terminal end faces on the finger side of the light guide are all drawn as flat in FIG. 29 to FIG. 31, such terminal end faces may also be formed circularly such as in a spherical shape or an R-shape, a tapered shape (knife edge shape) in which the height becomes lower from the outside toward the inside of the case 10, or the height contrarily becomes higher, a wave shape, or a non-circular shape such as of a micro lens array.

The light guide is configured from transparent glass or transparent resin. The light guide may include a light diffusion material such as silicon or aluminum.

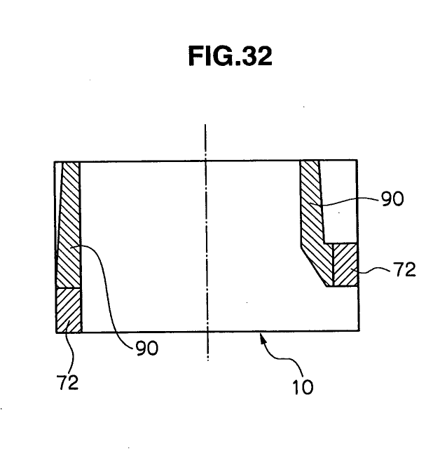

FIG. 32 is a view showing a frame format where the left and right light guides 90 are configured in an asymmetrical shape in relation to the case 10. When mounting the vein authentication apparatus on an electronic device such as a mobile phone, the configuration of the vein authentication apparatus must be designed so as to avoid the original components of the electronic device.

FIG. 32 shows an example thereof, and the LED 72 for supplying light to the light guide on the observer's right side is moved to the upper side of the case, and shows that it is bent perpendicularly toward the vicinity of the terminal end of the light guide 90 toward the LED 72.

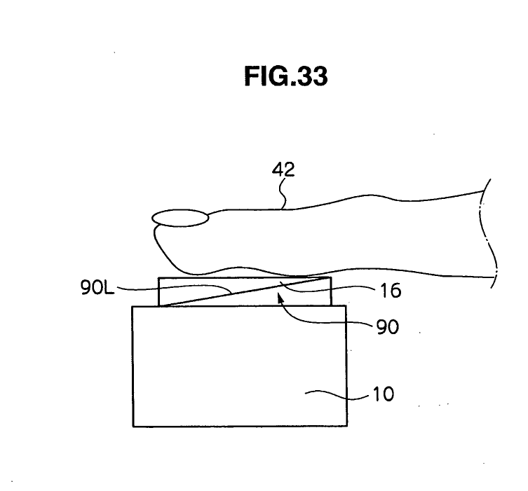

In addition, preferably, the case 10 is adjusted so that the height position in the case 10 of the light exit port 14 (refer to FIG. 19) to which the light guide 90 faces, or the height of the light guide 90 becomes tapered to gradually become higher at the palm side in comparison to the fingertip side as shown in FIG. 33. In FIG. 33, reference numeral 90L shows the upper end of the light guide.

This is because the radius of the finger at the fingertip side is smaller than the radius of the finger of the finger base side even in the vicinity of the first joint of the finger. In other words, the position of the exit port is changed in order to guide the light to the center of the lateral face of the finger. As a result of the position of the exit port being changed, the height of the light guide and the shape of the finger-side end face are also changed as needed.

In the foregoing embodiments, although the lens unit was configured from two groups of two lenses, the configuration is not limited thereto, and the lens unit may be configured from one lens or three or more lenses so as long as it possessed the demanded lens characteristics.

Further, the target of applying the finger vein authentication apparatus is not limited to a mobile phone, and, needless to say, the finger vein authentication apparatus can also be applied to various information processing apparatuses such as a PDA, laptop computer and the like. The information processing apparatus is not limited to the above, the finger vein authentication apparatus according to the present invention can also be mounted on cars and entrance/exit management apparatuses.

Moreover, although a protrusion was provided as the designation means for designating the position where the first joint of the finger is to be mounted on the case, the configuration is not limited thereto, and another designation means such as a symbol or a mark showing the position to which the first joint of the finger is to be placed may also be used.

Further, in the foregoing embodiments, although the finger vein authentication apparatus is provided to the planar face of the mobile phone, the finger vein authentication apparatus may also be provided to the bottom face, lateral face or front face of the mobile phone.

Moreover, although the foregoing embodiments explained a case where the pulp side of the finger was presented to the case 10 to take an image of the veins from the finger pulp side, the lateral face or the back side of the finger may be presented to the case 10, and authentication may be performed using the veins on the lateral face side or the back side of the finger. In particular, when taking an image of the back side of the finger, a clear image of veins can be obtained by taking the image in a state where the finger is bent.

Although the periphery of the first joint of the finger was imaged in the foregoing embodiments, the periphery of the second joint of the finger or portions other than the joint may also be used for the authentication.

The embodiments described above are merely example, and the present invention shall not in any way be limited by the foregoing embodiments.

What is claimed is:

1. A finger vein authentication apparatus, comprising:
a case for mounting a finger;
a light source for emitting light toward the finger mounted on the case;
an image sensor for taking an image of the interior portion of the finger with the light;
a lens apparatus having a lens unit for imaging the light from the finger to the image sensor; and
an image processor having a pattern extractor for extracting a vein pattern of the finger from the image taken with the image sensor, and an image corrector for correcting the strain of the image.

2. The finger vein authentication apparatus according to claim 1,
wherein a focal distance of the lens unit is 0.15 mm or greater and 0.5 mm or less;
wherein an object-side maximum field angle thereof is 100° or greater;
wherein a paraxial magnification is 0.04 or greater and 0.1 or less;
wherein an optical strain thereof is −60% to +50%; and
wherein a distance between the finger and the image sensor is 5 mm or greater and 12 mm or less.

3. The finger vein authentication apparatus according to claim 2,
wherein the focal distance of the lens unit is 0.15 mm or greater and 0.20 mm or less;
wherein the paraxial magnification thereof is 0.04 or greater and 0.06 or less;
wherein the optical strain is −2% to +50%; and
wherein the distance between the finger and the image sensor is 8 mm or less.

4. The finger vein authentication apparatus according to claim 1,
wherein the lens unit is configured such that a sensitivity ratio at the object-side maximum field angle is restricted to be within a prescribed range.

5. The finger vein authentication apparatus according to claim 1,
wherein the sensitivity ratio of the lens unit at the object-side maximum field angle is 10% or greater and 65% or less.

6. The finger vein authentication apparatus according to claim 5,
wherein the sensitivity ratio of the lens unit at the object-side maximum field angle is 40% or greater and 65% or less.

7. The finger vein authentication apparatus according to claim 1,
wherein the light source is configured to emit near-infrared light from a lateral face of the finger.

8. The finger vein authentication apparatus according to claim 1,
wherein the lens unit is configured from a concave lens and a convex lens.

9. The finger vein authentication apparatus according to claim 1,
wherein, after the image corrector corrects the strain of the image taken with the image sensor, the pattern extractor extracts the vein pattern from the corrected image.

10. The finger vein authentication apparatus according to claim 1,
wherein, after the pattern extractor extracts the vein pattern from the taken image, the image corrector corrects the strain of the extracted vein pattern.

11. The finger vein authentication apparatus according to claim 1,
further comprising a light guide for guiding light generated from the light source to an irradiation port of the light provided to the case.

12. The finger vein authentication apparatus according to claim 11,
wherein an exit port of the light is provided to the case in the vicinity of a lateral face in a longitudinal direction of the finger.

13. The finger vein authentication apparatus according to claim 1,
wherein the case is provided with designation means for designating the position where the first joint of the finger is to be mounted.

14. The finger vein authentication apparatus according to claim 1,
wherein the case is provided with a protrusion formed along a lateral face of the finger.

15. A finger vein authentication apparatus, comprising:
a case for mounting a finger;
a light source for emitting light toward the finger;
an image sensor for taking an image of the interior portion of the finger with the light;
a lens apparatus having a lens unit for imaging the light from the finger to the image sensor;
an image processor having a pattern extractor for extracting a vein pattern of the finger from the image taken with the image sensor, and an image corrector for correcting a strain of the image; and
a light guide for guiding light generated from a light source to an irradiation port of the light provided to the case;
wherein an exit port of the light is provided to the case in the vicinity of a lateral face in a longitudinal direction of the finger; and
wherein the light guide emits light from the light source toward the lateral face of the finger.

16. The finger vein authentication apparatus according to claim 15,
wherein the light guide emits light from the exit port along a tangential direction of the lateral face of the finger.

17. The finger vein authentication apparatus according to claim 1,
wherein the lens unit is a lens unit having the characteristics of a short focus, wide angle lens.

18. An information processing apparatus, comprising:
the finger vein authentication apparatus according to claim 1; and
a personal authentication apparatus for performing personal authentication based on an image of the strain-corrected vein pattern output from the finger vein authentication apparatus;
wherein the information processing apparatus performs electronic processing based on the authentication result of the personal authentication apparatus.

19. An information processing apparatus, comprising:
the finger vein authentication apparatus according to claim 15; and
a personal authentication apparatus for performing personal authentication based on an image of the strain-corrected vein pattern output from the finger vein authentication apparatus;
wherein the information processing apparatus performs electronic processing based on the authentication result of the personal authentication apparatus.
